(19) United States
(12) Patent Application Publication
(10) Pub. No.: US 2023/0103991 A1
(43) Pub. Date: Apr. 6, 2023

(54) Dynamic RACH Response Backoff Indicator

(71) Applicant: Parallel Wireless, Inc., Nashua, NH (US)

(72) Inventors: Benjamin Abramovsky, Petah Tiqwa (IL); Ido Shaked, Alfei Menashe (IL); Nimrod Gradus, Givatayim (IL); Efi Dror, Kadima-Zoran (IL); Ofek Toledano, Holon (IL)

(21) Appl. No.: 17/930,067

(22) Filed: Sep. 6, 2022

Related U.S. Application Data
(60) Provisional application No. 63/240,398, filed on Sep. 3, 2021.

(51) Int. Cl. H04W 74/08

(52) U.S. Cl. CPC H04W 74/085; H04W 74/0866

(57) ABSTRACT

In a first embodiment, a method for determining a dynamic RACH response backoff indicator is disclosed, comprising: estimating a load on the PRACH, based on a number of preambles detected for each PRACH slot, noise floor level, and other Phy features; and using this as an input to perform dynamic backoff indicator selection. In a second embodiment, a method for determining dynamic RACH response backoff indicator is disclosed, comprising: determining, by using the information provided by the connected UEs, how much effort was required to connect with an eNB; and deciding, by a dynamic core allocation, if a zero backoff indicator can be used or a non-zero backoff indicator value is needed to be used.

### CROSS-REFERENCE TO RELATED APPLICATIONS

This application claims priority under 35 U.S.C. § 119(e) to U.S. Provisional Patent Application No. 63/240,398, filed Sep. 3, 2021 and titled “Dynamic RACH Response Backoff Indicator,” which is hereby incorporated by reference in its entirety. This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

There are cases where a UE has to send another PRACH after it already sent a PRACH. The most common cases would be as follows. i) UE sent a PRACH but didn't get a RAR for some reason; or ii) UE sent a PRACH and got RAR, but the RAPID in the RAR is not for the UE.

In this case, UE is supposed to send another PRACH. In this case, UE would have a question, saying “When/How soon do I have to send the next PRACH?” Backoff Indicator is a special MAC subheader that carries the parameter indicating the time delay between a PRACH and the next PRACH.

### BRIEF DESCRIPTION OF THE DRAWINGS

FIG. 1 shows a prior art diagram showing a backoff indicator (BI) MAC header.

FIG. 2 is a first simulation result showing a number of UEs performing a RACH, in accordance with some embodiments.

FIG. 3 is a second simulation result showing a number of UEs performing a RACH, in accordance with some embodiments.

FIG. 4 is a sequence diagram showing a request made from a RAN to a UE, in accordance with some embodiments.

FIG. 5 is a flowchart of a stack-based dynamic BI algorithm, in accordance with some embodiments.

FIG. 6 is a schematic diagram of a multi-RAT core network, in accordance with some embodiments.

FIG. 7 is a system diagram of an enhanced base station, in accordance with some embodiments.

FIG. 8 is a system diagram of a coordinating server, in accordance with some embodiments.

### SUMMARY

In a first embodiment, a method for determining a dynamic RACH response backoff indicator is disclosed, comprising: estimating a load on the PRACH, based on a number of preambles detected for each PRACH slot, noise floor level, and other Phy features; and using this as an input to perform dynamic backoff indicator selection.

In a second embodiment, a method for determining dynamic RACH response backoff indicator is disclosed, comprising: determining, by using the information provided by the connected UEs, how much effort was required to connect with an eNB; and deciding, by a dynamic core allocation, if a zero backoff indicator can be used or a non-zero backoff indicator value is needed to be used.

### DETAILED DESCRIPTION

In LTE when eNB sends RACH response it can send also a backoff indicator (BI) information element (IE) causing all the UEs which their RACH wasn't answered to wait random time between [0 and BI value] in milliseconds before trying to access the eNB again.

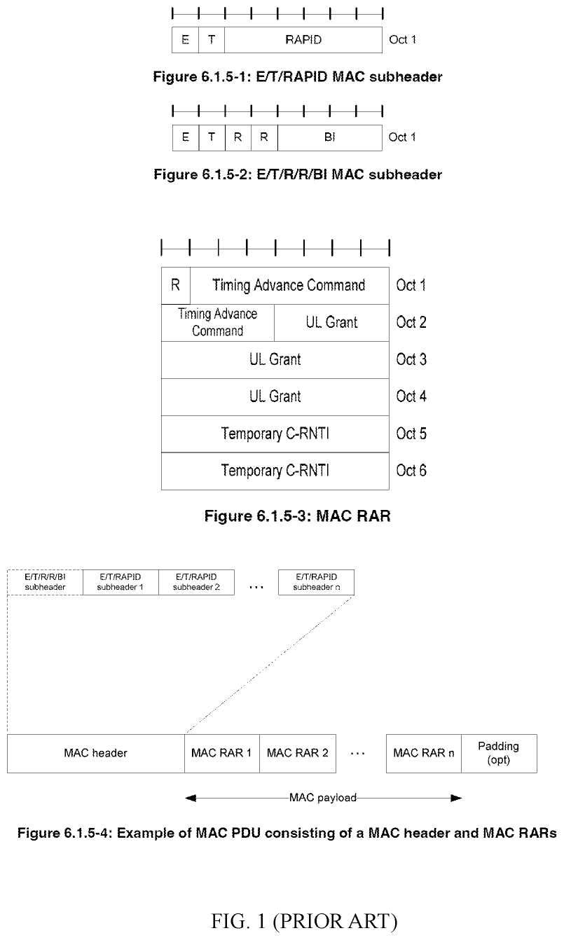

FIG. 1 shows a prior art diagram showing RAR (RACH Response) message format including BI sub-header. Further information is also available in LTE; Evolved Universal Terrestrial Radio Access (E-UTRA); Medium Access Control (MAC) protocol specification (3GPP TS 36.321 version 15.2.0 Release 15), which is hereby incorporated by reference in its entirety.

TABLE 1
Backoff Parameter Values

| | Backoff Parameter |
|---|---|
| Index | value (ms) |
| 0 | 0 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | Reserved |
| 14 | Reserved |

The reserved vales of the backoff parameter if received by the current release version UEs shall be taken as 960 ms, in some embodiments.

LTE/4G allows eNB to configure Backoff Indicator to divide the number of UEs trying to access the eNB between several RACH Slots. As it is good to use Backoff Indicator when there is high load on the PRACH channel but when it is set to non-zero value the average time for UE to access the eNB is increased, we should have dynamic mechanism which decides, given the current state, what the Backoff Indicator value should be. In this disclosure a Stack based dynamic BI solution is presented.

This idea will help eNB to balance between UE access time and and also to cope with large number of UEs and is relevant especially in urban scenarios.

UE has limited number of times it can send RACH to try to access an eNB. This parameter called preambleTransMax and it can have values between 3 to 200:

| | |
|---|---|
| PreambleTransMax := | ENUMERATED { |
| | n3, n4, n5, n6, n7, n8, n10, n20, n50, |
| | n100, n200} |

Every eNB has limited number of RACH messages with different preambles it can identify and limited number of RACH it can respond to with RACH response message due to implementation and system limitations.

If BI value is 0 and large number of UEs are trying to access the eNB using the PRACH channel, all the UEs will send every PRACH slot preamble, causing the situation that only a small portion of them can be answered by RACH Response. This will cause UEs to reach their PreambleTransMax and search for other eNB/RAT.

If BI value is very large, the UEs will wait for long time (up to 1 sec) between two consecutive preamble transmission. Doing so will cause much longer access time.

By simple Matlab simulation we can illustrate the problem:

Suppose we have large number of UEs arriving to our eNB (e.g. train station) in very short period of time (random number between t=[0,0.5] sec) and our eNB is capable to respond with RAR to 3 UEs every PRACH slot.

With our simulation we can see how much time it takes to our eNB handle all the UEs and what percentage of the group reached PreambleTransMax and were lost to our eNB.

For BI 0 the mean time to finish with the registration of all the UEs is low (less than 0.9 sec from the beginning of the arrival window of the UEs) but we see that for very large number of UEs very high percentage reach the PreambleTransMax.

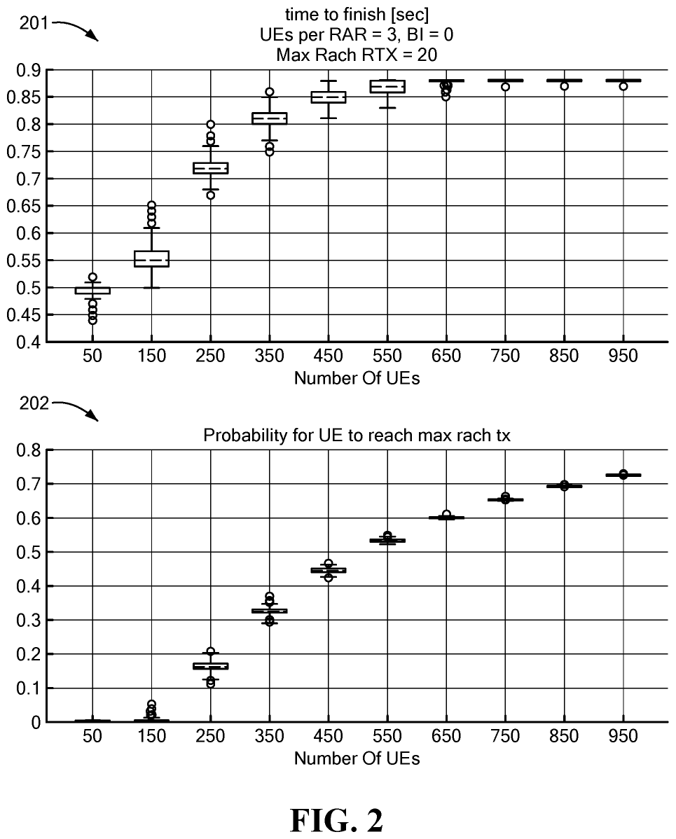

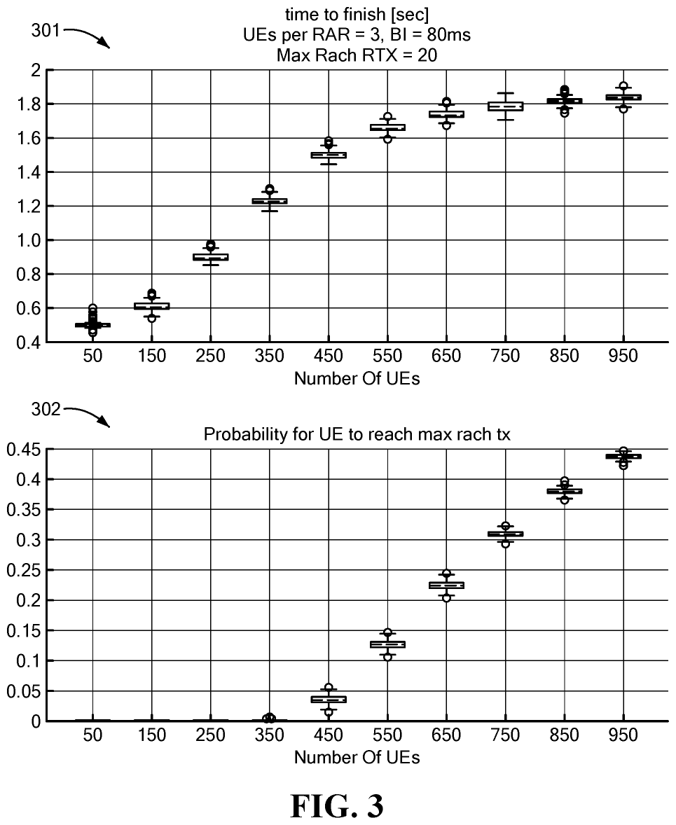

For BI=80 ms the percentage of UEs reaching to PreambleTransMax dropped significantly but the total time to finish handling all the UEs increased by a multiple of 2 as illustrated by FIG. 3 compared to FIG. 2.

Having fixed BI configuration as illustrated below can be problematic as it can significantly increase the UE access time or cause the UE to reach PreambleTransMax.

If we could have dynamic way to configure the BI in way that matches the current load on the PRACH we could benefit from the two extremes when needed. The question is how to do this.

Solving this problem can help our eNB product to have better performance in urban environment and other extreme cases.

It is desirable to have a way to dynamically configure the BI as function of the load or the effort needed by UE to gain access to the eNB.

In this document we'll cover Stack Based solution—which is based on UE Information query as input to dynamic BI selection algorithm.

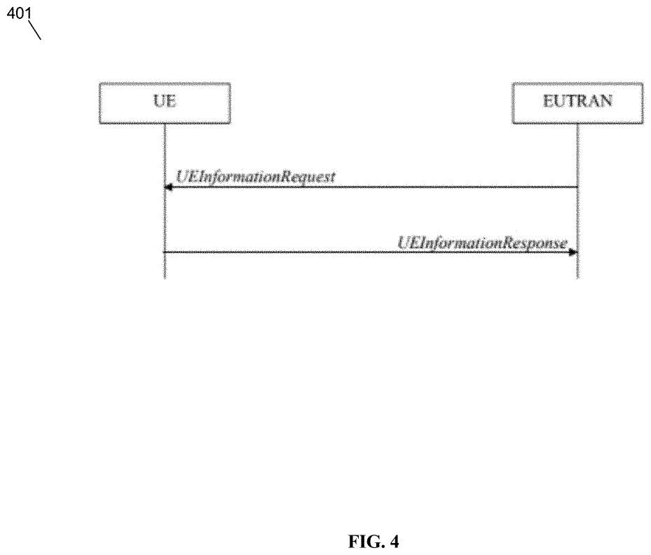

FIG. 4 is a sequence diagram showing a request made from a RAN to a UE, in accordance with some embodiments. In a first embodiment, the eNB can request connected UE to send its UE information following FIG. 4. This information includes the number of preambles used by the UE to gain access to the eNB.

| UEInformationResponse-r9-IEs ::= | SEQUENCE { | |
|---|---|---|
| rach-Report-r9 | SEQUENCE { | |
| numberofPreamblesSent-r9 | INTEGER (1..200), | |
| contentionDetected-r9 | BOOLEAN | |
| } | | OPTIONAL, |
| rlf-Report-r9 | RLF-Report-r9 | OPTIONAL, |

| | | |
|---|---|---|
| nonCriticalExtension | UEInformationResponse-v930-IEs | OPTIONAL |

}

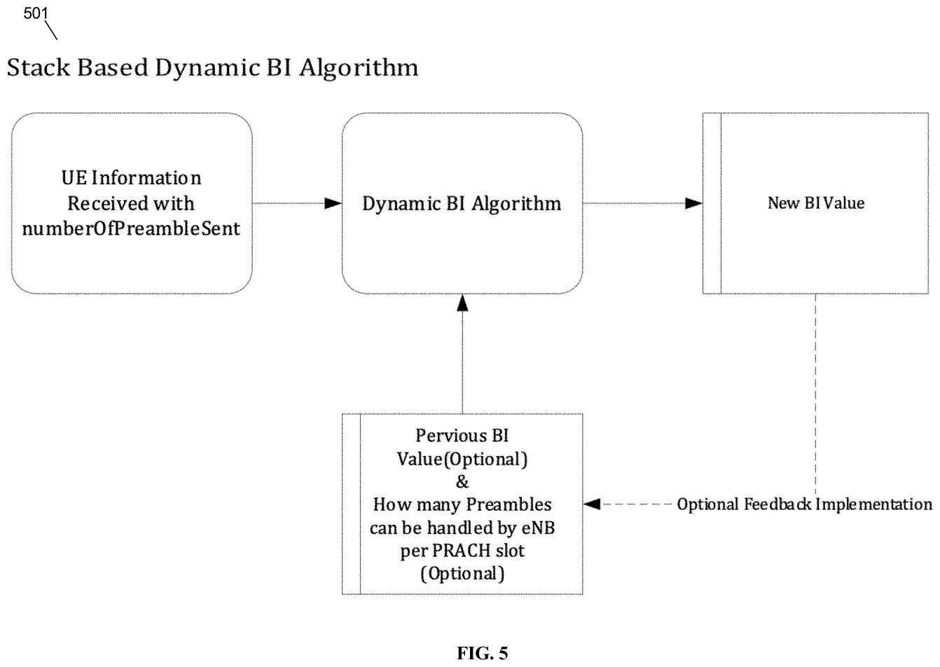

FIG. 5 is a flowchart of a stack-based dynamic BI algorithm, in accordance with some embodiments.

By using the information provided by the connected UEs regarding how much effort it took them to connect with the eNB, the dynamic core allocation can decide if zero BI can be used or non-zero BI value is needed to be used.

This method measures the right parameter which when exceeding the value configured by the eNB is causing the UE to move to another cell/RAT. However, it requires more time to understand that there is load on the PRACH as it requires the UE to be connected to the eNB.

In a second embodiment, we can use here a Phy based solution by estimating the load on the PRACH taking as input, e.g., the number of preambles detected each PRACH slot, noise floor level and other Phy features, and use this as input to a dynamic BI selection algorithm.

The PHY layer usually has an entity whose role is to detect preambles which were transmitted over the current PRACH slot. The performance of such entity can be affected by PUCCH transmission, number of UEs transmitting preambles at the same time and by the channel affect for each transmitted preamble.

Using the number of detected preambles, the noise floor level and other features the dynamic BI Allocation algorithm can decide if we need to use non-zero BI value or 0 BI value is fine to use (also by taking into account the max number of preambles the eNB can handle each PRACH slot)

This option is based mostly upon the number of detected preambles, the actual number can be higher or smaller . . . this method however is very responsive and reacts to load right away compared to the Stack based approach.

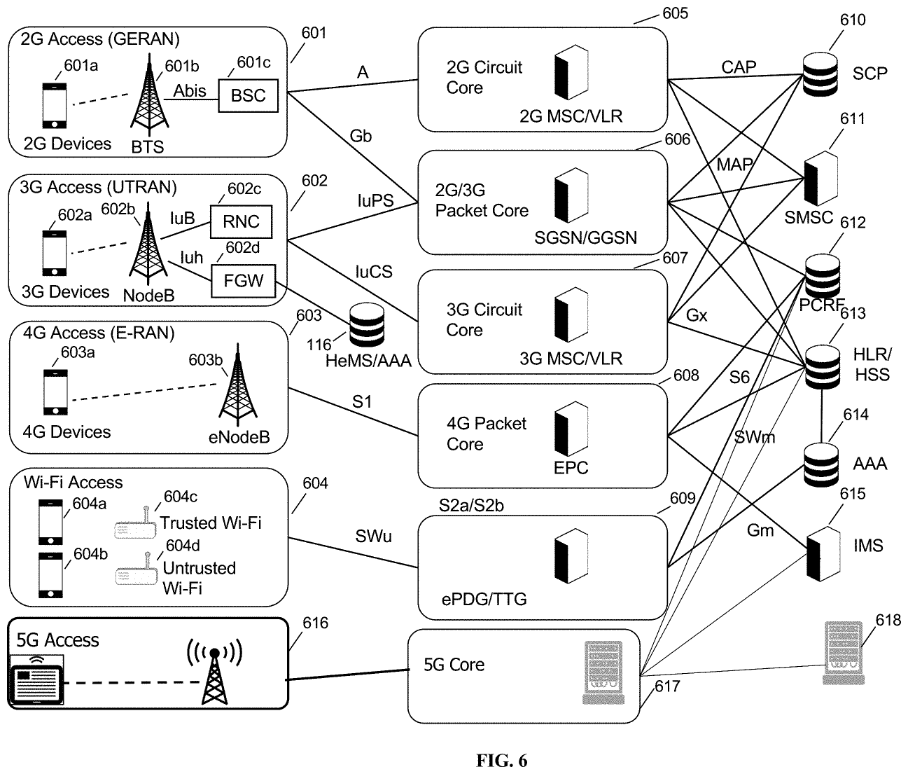

FIG. 6 is a schematic diagram of a multi-RAT core network, in accordance with some embodiments. The diagram shows a plurality of “Gs,” including 2G, 3G, 4G, 5G and Wi-Fi. 2G is represented by GERAN 601, which includes a 2G device 601a, BTS 601b, and BSC 601c. 3G is represented by UTRAN 602, which includes a 3G UE 602a, nodeB 602b, RNC 602c, and femto gateway (FGW, which in 3GPP namespace is also known as a Home nodeB Gateway or HNBGW) 602d. 4G is represented by EUTRAN or E-RAN 603, which includes an LTE UE 603a and LTE eNodeB 603b. Wi-Fi is represented by Wi-Fi access network 604, which includes a trusted Wi-Fi access point 604c and an untrusted Wi-Fi access point 604d. The Wi-Fi devices 604a and 604b may access either AP 604c or 604d. In the current network architecture, each “G” has a core network. 2G circuit core network 605 includes a 2G MSC/VLR; 2G/3G packet core network 606 includes an SGSN/GGSN (for EDGE or UMTS packet traffic); 3G circuit core 607 includes a 3G MSC/VLR; 4G circuit core 608 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 630, the SMSC 631, PCRF 632, HLR/HSS 633, Authentication, Authorization, and Accounting server (AAA) 634, and IP Multimedia Subsystem (IMS) 635. An HeMS/AAA 636 is present in some cases for use by the 3G UTRAN. The diagram is used to indicate schematically the basic functions of each network as known to one of skill in the art, and is not intended to be exhaustive. For example, 5G core 617 is shown using a single interface to 5G access 616, although in some cases 5G access can be supported using dual connectivity or via a non-standalone deployment architecture.

Noteworthy is that the RANs 601, 602, 603, 604 and 636 rely on specialized core networks 605, 606, 607, 608, 609, 637 but share essential management databases 630, 631, 632, 633, 634, 635, 638. More specifically, for the 2G GERAN, a BSC 601c is required for Abis compatibility with BTS 601b, while for the 3G UTRAN, an RNC 602c is required for Iub compatibility and an FGW 602d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. The present invention is also applicable for 5G networks since the same or equivalent functions are available in 5G. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

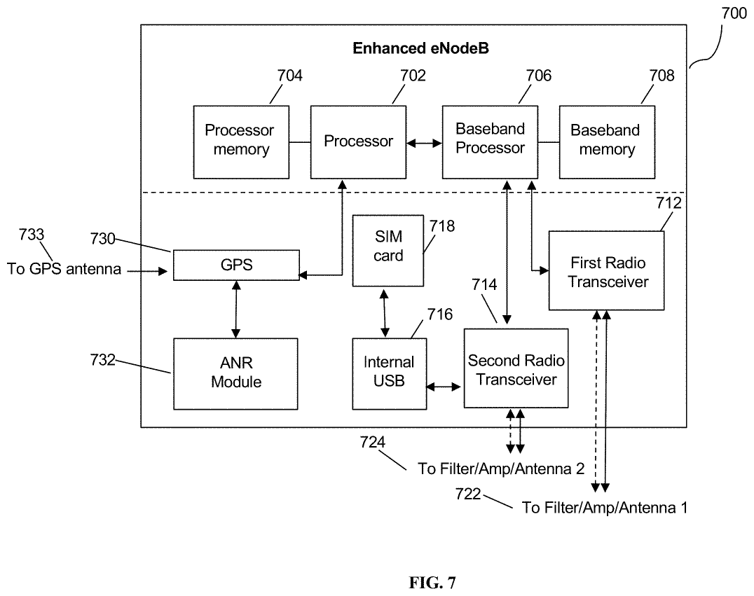

FIG. 7 is a system diagram of an enhanced base station, in accordance with some embodiments. eNodeB 700 may include processor 702, processor memory 704 in communication with the processor, baseband processor 706, and baseband processor memory 708 in communication with the baseband processor. Mesh network node 700 may also include first radio transceiver 712 and second radio transceiver 714, internal universal serial bus (USB) port 716, and subscriber information module card (SIM card) 718 coupled to USB port 716. In some embodiments, the second radio transceiver 714 itself may be coupled to USB port 716, and communications from the baseband processor may be passed through USB port 716. The second radio transceiver may be used for wirelessly backhauling eNodeB 700.

Processor 702 and baseband processor 706 are in communication with one another. Processor 702 may perform routing functions, and may determine if/when a switch in network configuration is needed. Baseband processor 706 may generate and receive radio signals for both radio transceivers 712 and 714, based on instructions from processor 702. In some embodiments, processors 702 and 706 may be on the same physical logic board. In other embodiments, they may be on separate logic boards.

Processor 702 may identify the appropriate network configuration, and may perform routing of packets from one network interface to another accordingly. Processor 702 may use memory 704, in particular to store a routing table to be used for routing packets. Baseband processor 706 may perform operations to generate the radio frequency signals for transmission or retransmission by both transceivers 710 and 712. Baseband processor 706 may also perform operations to decode signals received by transceivers 712 and 714. Baseband processor 706 may use memory 708 to perform these tasks.

The first radio transceiver 712 may be a radio transceiver capable of providing LTE eNodeB functionality, and may be capable of higher power and multi-channel OFDMA. The second radio transceiver 714 may be a radio transceiver capable of providing LTE UE functionality. Both transceivers 712 and 714 may be capable of receiving and transmitting on one or more LTE bands. In some embodiments, either or both of transceivers 712 and 714 may be capable of providing both LTE eNodeB and LTE UE functionality. Transceiver 712 may be coupled to processor 702 via a Peripheral Component Interconnect-Express (PCI-E) bus, and/or via a daughtercard. As transceiver 714 is for providing LTE UE functionality, in effect emulating a user equipment, it may be connected via the same or different PCI-E bus, or by a USB bus, and may also be coupled to SIM card 718. First transceiver 712 may be coupled to first radio frequency (RF) chain (filter, amplifier, antenna) 722, and second transceiver 714 may be coupled to second RF chain (filter, amplifier, antenna) 724.

SIM card 718 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 700 is not an ordinary UE but instead is a special UE for providing backhaul to device 700.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 712 and 714, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 702 for reconfiguration.

A GPS module 730 may also be included, and may be in communication with a GPS antenna 732 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 732 may also be present and may run on processor 702 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

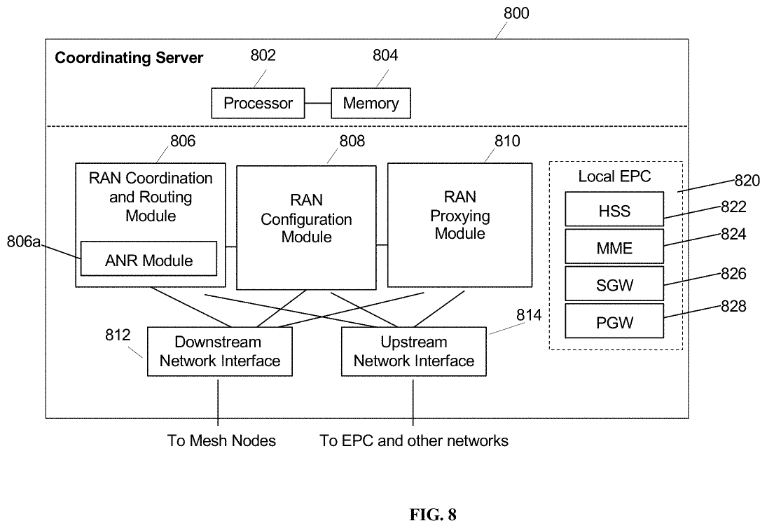

FIG. 8 shows is a coordinating server for providing services and performing methods as described herein, in accordance with some embodiments. Coordinating server 800 includes processor 802 and memory 804, which are configured to provide the functions described herein. Also present are radio access network coordination/routing (RAN Coordination and routing) module 806, including ANR module 806a, RAN configuration module 808, and RAN proxying module 810. The ANR module 806a may perform the ANR tracking, PCI disambiguation, ECGI requesting, and GPS coalescing and tracking as described herein, in coordination with RAN coordination module 806 (e.g., for requesting ECGIs, etc.). In some embodiments, coordinating server 800 may coordinate multiple RANs using coordination module 806. In some embodiments, coordination server may also provide proxying, routing virtualization and RAN virtualization, via modules 810 and 808. In some embodiments, a downstream network interface 812 is provided for interfacing with the RANs, which may be a radio interface (e.g., LTE), and an upstream network interface 814 is provided for interfacing with the core network, which may be either a radio interface (e.g., LTE) or a wired interface (e.g., Ethernet).

Coordinator 800 includes local evolved packet core (EPC) module 820, for authenticating users, storing and caching priority profile information, and performing other EPC-dependent functions when no backhaul link is available. Local EPC 820 may include local HSS 822, local MME 824, local SGW 826, and local PGW 828, as well as other modules. Local EPC 820 may incorporate these modules as software modules, processes, or containers. Local EPC 820 may alternatively incorporate these modules as a small number of monolithic software processes. Modules 806, 808, 810 and local EPC 820 may each run on processor 802 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for determining a dynamic RACH response backoff indicator, comprising:
estimating a load on the PRACH, based on a number of preambles detected for each PRACH slot, noise floor level, and other Phy features; and
using this as an input to perform dynamic backoff indicator selection.

2. A method for determining dynamic RACH response backoff indicator, comprising:
determining, by using the information provided by the connected UEs, how much effort was required to connect with an eNB; and
deciding, by a dynamic core allocation, if a zero backoff indicator can be used or a non-zero backoff indicator value is needed to be used.
